(19) United States
(12) Patent Application Publication
(10) Pub. No.: US 2012/0064899 A1
(43) Pub. Date: Mar. 15, 2012

(54) Method and Apparatus for Providing a Dynamic Paging Period

(75) Inventor: Deogratius Musiige, Albertslund (DK)

(73) Assignee: NOKIA CORPORATION, Espoo (FI)

(21) Appl. No.: 13/320,728

(22) PCT Filed: May 15, 2009
(86) PCT No.: PCT/IB2009/052039

§ 371 Date: Nov. 15, 2011

(51) Int. Cl. H04W 40/00

(52) U.S. Cl. 455/445

(57) ABSTRACT

An apparatus for providing determination of a dynamic paging period may include at least one processor and at least one memory storing computer program code configured to, with the at least one processor, cause the apparatus or another apparatus to perform at least receiving an indication of movement information regarding movement of a mobile terminal relative to at least a portion of a coverage area of a network device configured to route messages to mobile terminals via a plurality of base stations associated with the network device, determining a dynamic paging period for the mobile terminal based on the movement information and providing the dynamic paging period to the mobile terminal. A corresponding method and computer program product are also provided.

### TECHNOLOGICAL FIELD

Embodiments of the present invention relate generally to communications technology and, more particularly, relate to an apparatus and method for providing a dynamic paging period.

### BACKGROUND

In order to provide easier or faster information transfer and convenience, telecommunication industry service providers are continually developing improvements to existing communication networks. As a result, wireless communication has developed increased reliability and quality and has become increasingly popular in recent years. Along with the expansion and improvement of wireless communication networks, mobile electronic devices used for wireless communication have also been continually improving. In this regard, due at least in part to reductions in size and cost, along with improvements in battery life and computing capacity, mobile electronic devices have become more capable, easier to use, and cheaper to obtain. Due to the now ubiquitous nature of mobile electronic devices, people of all ages and education levels are utilizing mobile terminals to communicate with other individuals or contacts, receive services and/or share information, media and other content.

With the proliferation of mobile terminals, and given the variety of services beyond just placing phone calls that can be accomplished with mobile terminals, many individuals are finding mobile terminals to be important parts of their work and social lives. Thus, being able to rely upon the availability of the mobile terminal is an important consideration for many users. However, since mobile terminals run on battery power, and since the number of tasks they can be used for are often numerous, battery conservation is a constant concern for mobile terminal users and therefore balancing utility with power consumption becomes an issue. In this regard, for example, if a user is waiting for a bus or an airplane and wants entertainment, or if a user is lost or has an accident in a remote location, the user would almost certainly like to have as much battery power available as possible despite the fact that the user may have been utilizing the mobile terminal for routine tasks in the meantime. Thus, the saving of battery power during routine operations is important.

Accordingly, it may be desirable to provide a mechanism by which battery power may be conserved.

### BRIEF SUMMARY OF EXEMPLARY EMBODIMENTS

A method and apparatus are therefore provided that may enable the provision of dynamic paging. In particular, the movement history of a mobile terminal may be taken into consideration with respect to determining a dynamic wakeup frequency for the mobile terminal so that if a mobile terminal has minimal or no movement, the wakeup frequency may be reduced. Meanwhile, if the mobile terminal is experiencing a relatively large amount of movement, the wakeup frequency may be increased. Accordingly, for example, mobile terminals (e.g., user equipment (UE) devices) may be able to wakeup less often and conserve more energy in situations in which movement is less likely to occur.

In one exemplary embodiment, a method of providing a dynamic paging period is provided. The method may include receiving an indication of movement information regarding movement of a mobile terminal relative to at least a portion of a coverage area of a network device configured to route messages to mobile terminals via a plurality of base stations associated with the network device, determining a dynamic paging period for the mobile terminal based on the movement information and providing the dynamic paging period to the mobile terminal.

In another exemplary embodiment, a computer program product for providing a dynamic paging period is provided. The computer program product may include at least one computer-readable storage medium having computer-executable program code instructions stored therein. The computer-executable program code instructions may include program code instructions for receiving an indication of movement information regarding movement of a mobile terminal relative to at least a portion of a coverage area of a network device configured to route messages to mobile terminals via a plurality of base stations associated with the network device, determining a dynamic paging period for the mobile terminal based on the movement information and providing the dynamic paging period to the mobile terminal.

In another exemplary embodiment, an apparatus for providing a dynamic paging period is provided. The apparatus may include at least one processor and at least one memory storing computer program code configured to, with the at least one processor, cause the apparatus or another apparatus to perform at least receiving an indication of movement information regarding movement of a mobile terminal relative to at least a portion of a coverage area of a network device configured to route messages to mobile terminals via a plurality of base stations associated with the network device, determining a dynamic paging period for the mobile terminal based on the movement information and providing the dynamic paging period to the mobile terminal.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an exemplary embodiment of the present invention;

FIG. 2 illustrates a schematic block diagram of an apparatus for providing dynamic paging period determination according to an exemplary embodiment of the present invention;

FIG. 3 illustrates one example of a flowchart showing the process of dynamic paging period determination according to an exemplary embodiment of the present invention;

FIG. 4 illustrates a transition state diagram in accordance with an exemplary embodiment of the present invention;

FIG. 5 shows the performance of a dynamic paging period determination approach with a set of assumed parameters according to an exemplary embodiment of the present invention; and

FIG. 6 illustrates a flowchart of a method of providing dynamic paging in accordance with an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Some embodiments of the present invention may provide a mechanism by which improvements may be experienced in relation to dynamic paging that may provide conservation of battery power for mobile terminals. In this regard, for example, rather than providing mobile terminals with a fixed or predefined paging interval defining the amount of time during which a mobile terminal may sleep or remain idle before waking up, at the paging interval, to listen to a paging channel to see if any call is incoming for the mobile terminal, embodiments of the present invention provide for a dynamic paging interval. The dynamic paging interval according to embodiments of the present invention may be determined by the mobile terminal or by a network entity, such as the mobile switching center (MSC) serving the mobile terminal. In some embodiments, the dynamic paging interval may be determined based at least in part on the residence time of a mobile terminal in a certain cell or in a certain region served by a particular MSC.

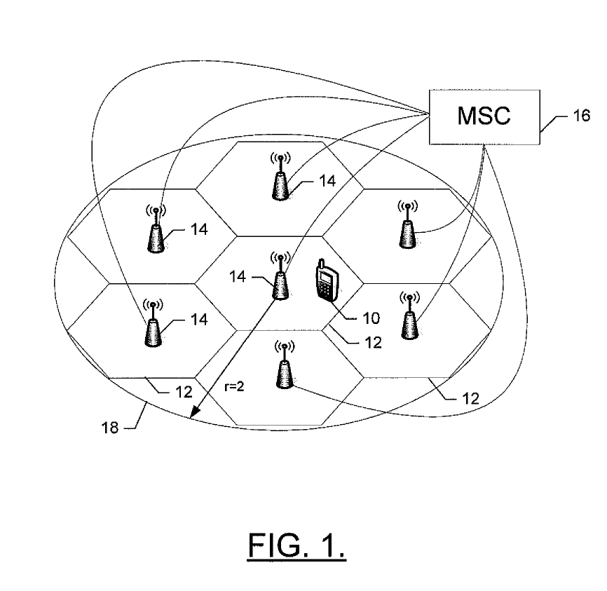

FIG. 1 illustrates a generic system diagram showing mobile terminal 10 positioned within one of a plurality of communication cells 12, each of which defines the coverage area for communication provided by a corresponding base site or base station (e.g., BS 14). The BS 14 may be a part of one or more cellular or wireless communication networks each of which includes elements desired to operate the network, such as a mobile switching center (MSC) 16. In operation, the MSC 16 may be capable of routing calls to and from the mobile terminal 10 when the mobile terminal 10 is making and receiving calls. The MSC 16 may also provide a connection to landline trunks when the mobile terminal 10 is involved in a call. In addition, the MSC 16 may be capable of controlling the forwarding of messages to and from the mobile terminal 10, and may also control the forwarding of messages for the mobile terminal 10 to and from a messaging center.

In an exemplary embodiment, the MSC 16 may be in communication with a particular group of BSs thereby defining an MSC coverage area 18. The MSC 16 may be coupled to a data network, such as a local area network (LAN), a metropolitan area network (MAN), and/or a wide area network (WAN). The MSC 16 may be directly coupled to the data network or may be coupled to a gateway device, and the gateway device may be coupled to a WAN, such as the Internet. In turn, devices such as processing elements (e.g., personal computers, server computers or the like) may be coupled to the mobile terminal 10 via the Internet.

In example embodiments, the mobile terminal 10 may be a mobile communication device such as, for example, a personal digital assistant (PDA), wireless telephone, mobile computing device, camera, video recorder, audio/video player, positioning device, game device, television device, radio device, or various other like devices or combinations thereof. Furthermore, although not shown in FIG. 1, the mobile terminal 10 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 may be enabled to communicate with a network and/or with other terminals by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

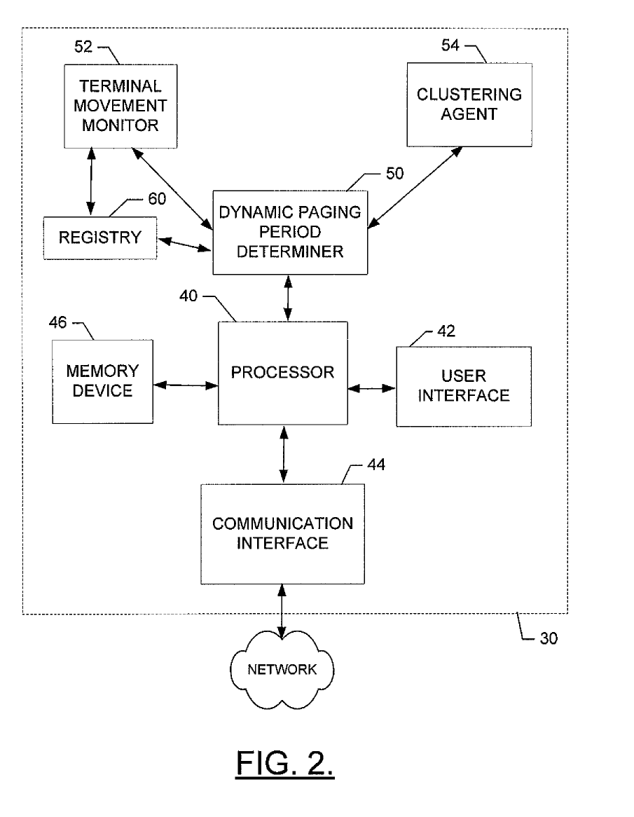

In an exemplary embodiment, the MSC 16 may be configured to control the provision of dynamic paging with respect to the mobile terminal 10 and/or other mobile terminals. As such, for example, the MSC 16 may include an apparatus configured to provide dynamic paging in accordance with an exemplary embodiment of the present invention. FIG. 2 illustrates a schematic block diagram of an apparatus 30 for providing dynamic paging according to an exemplary embodiment of the present invention. An exemplary embodiment of the invention will now be described with reference to FIG. 2, in which certain elements of the apparatus 30 for providing dynamic paging are displayed. The apparatus 30 of FIG. 2 may be employed, for example, on a network communication device (e.g., the MSC 16), although in some cases, some portions of the apparatus 30 may be distributed and therefore may be resident on other devices (e.g., the mobile terminal 10 and/or the BS 14). However, it should be noted that the components, devices or elements described below may not be mandatory and thus some may be omitted in certain embodiments. Additionally, some embodiments may include further components, devices or elements beyond those shown and described herein.

Referring now to FIG. 2, an apparatus for providing a dynamic paging capability is provided. The apparatus 30 may include or otherwise be in communication with a processor 40, a user interface 42, a communication interface 44 and a memory device 46. The memory device 46 may include, for example, one or more volatile and/or non-volatile memory devices. The memory device 46 may be configured to store information, data, applications, instructions or the like for enabling the apparatus to carry out various functions in accordance with exemplary embodiments of the present invention. For example, the memory device 46 could be configured to buffer input data for processing by the processor 40. Additionally or alternatively, the memory device 46 could be configured to store instructions for execution by the processor 40.

The processor 40 may be embodied in a number of different ways. For example, the processor 40 may be embodied as various processing means such as one or more instances of a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 40 may be configured to execute instructions stored in the memory device 46 or otherwise accessible to the processor 40. As such, whether configured by hardware or software methods, or by a combination thereof, the processor 40 may represent an entity (e.g., physically embodied in circuitry) capable of performing operations according to embodiments of the present invention while configured accordingly. Thus, for example, when the processor 40 is embodied as an ASIC, FPGA or the like, the processor 40 may be specifically configured hardware for conducting the operations described herein. Alternatively, as another example, when the processor 40 is embodied as an executor of software instructions, the instructions may specifically configure the processor 40 to perform the functions, algorithms and/or operations described herein when the instructions are executed. However, in some cases, the processor 40 may be a processor of a specific device (e.g., a mobile terminal or network device such as the MSC 16) adapted for employing embodiments of the present invention by further configuration of the processor 40 by instructions for performing the functions, algorithms and/or operations described herein.

Meanwhile, the communication interface 44 may be any means such as a device or circuitry embodied in either hardware, software, or a combination of hardware and software that is configured to receive and/or transmit data from/to a network and/or any other device or module in communication with the apparatus. In this regard, the communication interface 44 may include, for example, an antenna (or multiple antennas) and supporting hardware and/or software for enabling communications with a wireless communication network. In fixed environments, the communication interface 44 may alternatively or also support wired communication. As such, the communication interface 44 may include a communication modem and/or other hardware/software for supporting communication via cable, digital subscriber line (DSL), universal serial bus (USB) or other mechanisms.

The user interface 42 may be in communication with the processor 40 to receive an indication of a user input at the user interface 42 and/or to provide an audible, visual, mechanical or other output to the user. As such, the user interface 42 may include, for example, a keyboard, a mouse, a joystick, a display, a touch screen, a microphone, a speaker, or other input/output mechanisms. In an exemplary embodiment in which the apparatus is embodied as a server or some other network devices, the user interface 42 may be limited, or eliminated. However, in an embodiment in which the apparatus is embodied as a communication device (e.g., the mobile terminal 10), the user interface 42 may include, among other devices or elements, any or all of a speaker, a microphone, a display, and a keyboard or the like.

In an exemplary embodiment, the processor 40 may be embodied as, include or otherwise control a dynamic paging period determiner 50. The dynamic paging period determiner 50 may further include or otherwise control a terminal movement monitor 52 (and in some cases an optional clustering agent 54). The dynamic paging period determiner 50, the terminal movement monitor 52 and the clustering agent 54 may each be any means such as a device or circuitry that may be operating in accordance with software or otherwise embodied in hardware or a combination of hardware and software (e.g., processor 40 operating under software control, the processor 40 embodied as an ASIC or FPGA specifically configured to perform the operations described herein, or a combination thereof) thereby configuring the device or circuitry to perform the corresponding functions of the dynamic paging period determiner 50, the terminal movement monitor 52 and the clustering agent 54, respectively, as described below. Thus, in examples in which software is employed, a device or circuitry (e.g., the processor 40 in one example) executing the software forms the structure associated with such means.

In an exemplary embodiment, the dynamic paging period determiner 50 may be configured to determine a dynamic paging period for one or more mobile terminals (e.g., including the mobile terminal 10) based on movement information of the corresponding one or more mobile terminals. The term “dynamic paging period” refers to the fact that the paging periods determined by the dynamic paging period determiner 50 are not predefined or fixed values, but are instead variable values that are set based on movement information of a mobile terminal which may be indicated by residence time information and/or location information. Residence time information may, for example, be indicative of or otherwise correspond to the time that the mobile terminal 10 spends in a particular region (e.g., any one of the cells 12 or in the MSC coverage area 18) and may be determined by any of a number of different ways. Location information may be indicative of the specific location of the mobile terminal 10 at any given time or at certain intervals, but may alternatively be indicative of the general region (e.g., cell or group of cells) in which the mobile terminal 10 is located or has been located over some period of time.

In some embodiments, residence time information may be an example of movement information. Residence time information may be determined by the residence time determiner 52. The terminal movement monitor 52 may be configured to determine residence time via any suitable mechanism. In some examples, the terminal movement monitor 52 may include a timer that determines the amount of time the mobile terminal 10 is resident in a particular region. Thus, for example, the terminal movement monitor 52 may be configured to count either up or down starting with the entry of the mobile terminal 10 into the particular region. The terminal movement monitor 52 may then be configured to provide residence time information to the dynamic paging period determiner 50 indicating that one or more predefined thresholds are reached, or that the timer has expired. Alternatively, the terminal movement monitor 52 may be configured to report residence time information such as the current time associated with the mobile terminal's presence in the particular region either continuously, at predefined intervals or in response to specific stimuli. The dynamic paging period determiner 50 may then utilize the residence time information as an example of movement information used to determine a dynamic paging period for the mobile terminal 10. In some examples, multiple timers may be running for multiple mobile terminals to enable dynamic paging period determinations to be made for each of the multiple terminals simultaneously or at predefined intervals.

In some cases, it may be desirable to avoid using timers. Thus, in some exemplary embodiments, the terminal movement monitor 52 may be configured to make determinations regarding movement information based on information other than directly measured timing values. In this regard, for example, in some cases the detection of movement of the mobile terminal 10 over a given period may give an indication of the movement information for the mobile terminal 10. In other words, for example, by monitoring the movement of the mobile terminal 10 into different cells, an indication may be provided with respect to the frequency of movement of the mobile terminal 10. The frequency of movement of the mobile terminal 10 may in turn be indicative of a likelihood of future movement of the mobile terminal 10 and therefore an indication of the probability that the mobile terminal 10 will either stay in the current region or move to another region. Thus, in some examples, a probability of terminal movement may be used as the movement information upon which dynamic paging period determinations may be made by the dynamic paging period determiner 50.

When a mobile terminal (e.g., the mobile terminal 10) moves into a new cell, the mobile terminal typically initializes itself by synchronizing with the BS of the corresponding cell entered. The synchronization typically occurs via a synchronizing channel and, via the synchronization, the mobile terminal acquires system specific information such as the cell identification (e.g., cell ID) of the cell entered. The cell ID may be acquired, for example, from a broadcast message over a broadcast channel either when the mobile terminal is initially turned on in a cell, when a call terminates in the cell, or when the mobile terminal enters the cell. According to an exemplary embodiment, the terminal movement monitor 52 may be configured to record or register (e.g., in a registry 60 that may be a portion of the memory device 46 or some other storage location) the cell IDs of cells entered in order to keep track of the number of registered cell IDs. Periodically, the registry 60 may be cleared. Thus, the number of registered cell IDs recorded at any given time may provide a general indication of the movement of the mobile terminal 10 over the period of time between clearances of the registry 60.

In an exemplary embodiment, the terminal movement monitor 52 may provide the number of registered cell IDs to the dynamic paging period determiner 50 as the movement information to form the basis upon which dynamic paging period determinations may be made by the dynamic paging period determiner 50. Moreover, the number of registered cell IDs may be provided for each respective mobile terminal that is served by the MSC 16. Clearance of the registry 60 associated with storing movement information for each respective one of the mobile terminals may be triggered by any of a number of events. For example, in some cases, the registry 60 may be cleared in response to termination of a call or in response to the mobile terminal 10 moving to a cell that is covered by another MSC.

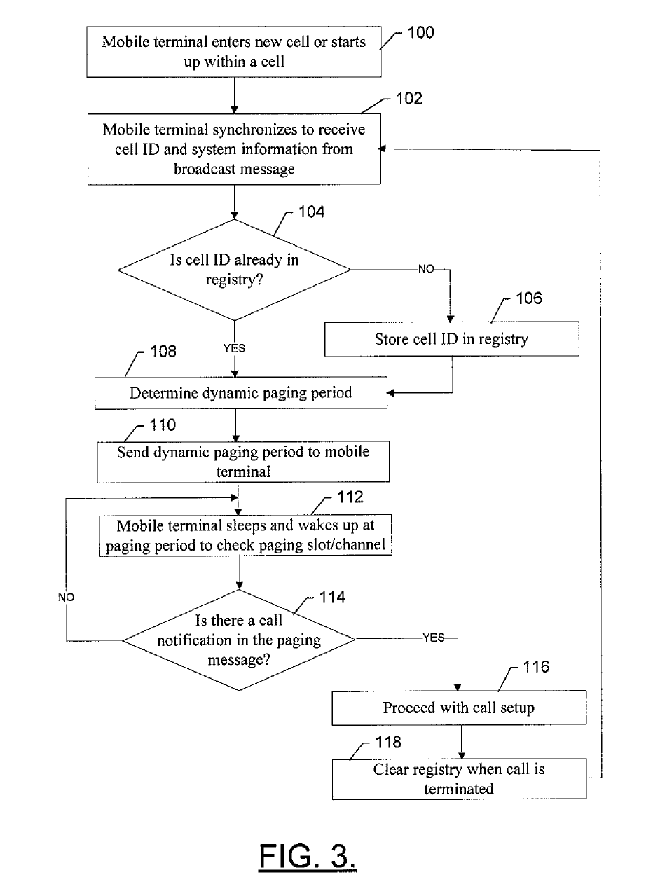

FIG. 3 illustrates one example of a flowchart showing the process of dynamic paging period determination according to an exemplary embodiment. In this regard, as shown in FIG. 3, movement of a mobile terminal into a new cell (or startup of the mobile terminal in a cell) at operation 100 may trigger further processes associated with dynamic paging. At operation 102, the mobile terminal may synchronize with the BS associated with the cell in which the mobile terminal is located and the mobile terminal may be provided with a cell ID for the cell. The cell ID may also be provided to the MSC in connection with the mobile terminal for storage in a registry. If the mobile terminal is in a cell associated with a new MSC, the registry may be cleared or reset. A decision may be made at operation 104 with respect to whether the registry already includes the cell ID. If not, the cell ID may be stored in the registry at operation 106. If the registry already includes the cell ID, or once the cell ID is stored in the registry, the MSC may determine a dynamic paging period based on the number of cell IDs in the registry at operation 108. The MSC may also determine the corresponding slot and/or paging channel for the mobile terminal during operation 108.

The MSC may then send the dynamic paging period to the mobile terminal at operation 110. The mobile terminal may then sleep and wake up after passage of the defined dynamic paging period in order to monitor the corresponding slot and paging channel at operation 112. A determination is then made at operation 114 as to whether there is a call notification for the mobile terminal at the paging slot/channel. If there is no paging message indicating a call notification, the mobile terminal repeats operation 112. However, if there is a paging message with a call notification, the mobile terminal proceeds with call setup at operation 116. After call setup and ultimately in response to call termination, the registry may be cleared at operation 118 and operation may return to operation 102.

The determination of the dynamic paging period at operation 108 may be performed, as indicated above, by the dynamic paging period determiner 50 based on movement information that, in this example, relates to the number of cell IDs in the registry. According to one example, the dynamic paging period determiner 50 may use the following equation pp(i)=min{max(ppₘᵢₙ,α·i),pₘₐₓ} (referred to hereinafter as equation (1)) for calculating a dynamic paging period (pp), in which the paging period is calculated as a function of i. In the example equation above, i is a value representing the number of elements (e.g., cell IDs) in the registry 60, α is a wake-up period proportional coefficient which may be a constant, and ppₘᵢₙ and ppₘₐₓ are the allowable minimum and maximum paging periods, respectively. In GSM, for example, the allowable minimum and maximum paging periods may be between two and nine “51 multiframes” where a “51 multiframe” is equivalent to 51*8*577 microseconds, which equals about 235 milliseconds. Thus, the allowable minimum and maximum paging periods for GSM may end up being between 0.470 and 2.12 seconds. However, other values may be determined for other communication networks.

In general, a higher number of cell IDs for determinations with respect to a particular MSC (or a high residence time if a timer is employed) indicates a higher probability of staying in the same region. For a higher probability of staying in the same region, the dynamic paging period determiner 50 of one exemplary embodiment is configured to assign a longer the dynamic paging period. Of course, a longer dynamic paging period generally means more sleep time for the mobile terminal 10 between checks of the paging channel and therefore greater battery power conservation. Thus, the dynamic paging period determiner 50 of an exemplary embodiment is configured to set a dynamic paging period based on movement information where the movement information is indicative of the probability of the mobile terminal 10 staying in the same region (e.g., same cell or same MSC coverage area).

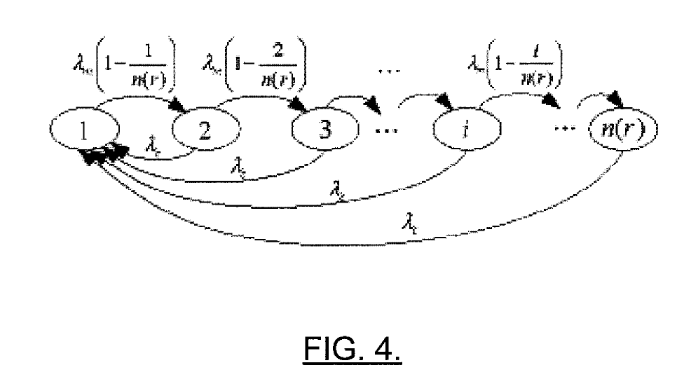

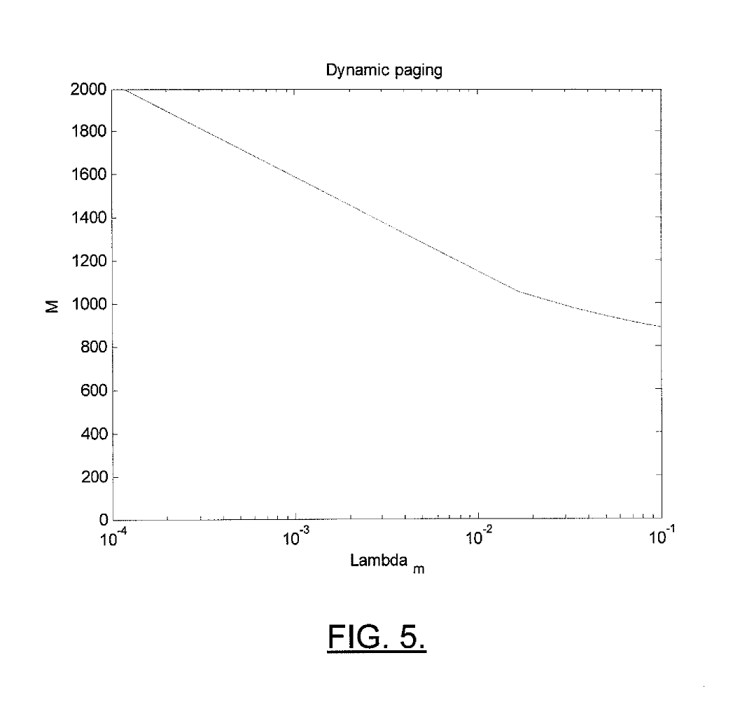

FIGS. 4 and 5 illustrate a performance evaluation of one exemplary embodiment of the present invention which will be described again in reference to FIG. 1. In this regard, as shown in FIG. 1, the coverage area of the MSC 16 may be divided into n(r) equivalent hexagonal cells. The variable r may represent the distance in cell units from the center of the center cell to the border of the MSC coverage area 18, which in this example makes r=2. It may also be assumed that the distribution of the inter-arrival time of calls for a mobile terminal is exponential with parameter λ_{c} and that the duration of a call that is setup may be approximated to have a call duration of D. Finally, assume that the distribution of the residence time of the mobile terminal in a particular cell is assumed to also be exponential with the parameter λₘ. Thus, when a mobile terminal makes an inter-cell movement, the mobile terminal moves to a randomly chosen cell among the n(r) cells in the MSC coverage area 18.

Given the assumptions above, a Markov chain having a state i, representing the number of registered cell IDs, may be defined. In a Markov chain, given the present state, the corresponding next state is stochastic or independent of past states. FIG. 4 represents a transition state diagram based on the assumptions described above and the corresponding non-zero elements of the transition matrix Q are given in the equation

$$\{ \begin{matrix}{q}_{1 , 1} = - {λ}_{m} ( 1 - \frac{1}{n ( r )} ) , \\ {q}_{n ( r ) , n ( r )} = - {λ}_{c} \\ {q}_{1 , i} = {λ}_{c} , i = 2 , 3 , … , n ( r ) \\ {q}_{i , i} = - \{ {λ}_{m} ( 1 - \frac{i}{n ( r )} ) + {λ}_{c} \} , i = 2 , 3 , … , n ( r ) - 1 \\ {q}_{i , i + 1} = {λ}_{m} ( 1 - \frac{i}{n ( r )} ) , i = 1 , 2 , … , n ( r ) - 1.\end{matrix}$$

Thereafter, by using the equation

$${\sum }_{i = 1}^{n ( r )} {π}_{i} and [ {π}_{1} , {π}_{2} , … , {π}_{n ( r )} ] \cdot \underline{\underline{Q}} = 0 ,$$

the steady state probability matrix may be computed using [π₁,π₂,π₃, . . . , πₙ₍ᵣ₎]=[1,0,0, . . . , 0]·Q′⁻¹, in which the value Q′ is the matrix that is obtained by adding 1 to each element of Q's first column. The wake-up frequency of the mobile terminal may then be defined at state i as

$$f = \frac{1}{pp ( i )} ,$$

where pp(i) is defined in equation (1). The average number of wake-ups during a duration t seconds, may be defined as:

$$M = ( t - {λ}_{c} \cdot t \cdot D ) \cdot {\sum }_{i = 1}^{n ( r )} {π}_{i} \cdot f ( i ) .$$

To illustrate the practicability of this approach, assume that the following variables are:
1. The GSM paging interval with PPₘᵢₙ=0.47 s,PPₘₐₓ=2.12 s as mentioned earlier.
2. The call duration D=60 s
3. Observation time t=0.5 hrs
4. λₘ=[1e−4:1e−1]
5. α=1.

Implementing the equation above for the average number of wake-ups during a duration t seconds, FIG. 5 shows the performance of a dynamic paging period determination approach with the assumed parameters above according to an exemplary embodiment. In FIG. 5, it can be seen that the average of the number of wake-ups (M) falls as the residence parameter λₘ(lambdaₘ) increases. In other words, as the residence parameter, λₘ(lambdaₘ), which is indicative of the probability of staying in the same region, increases, the number of wake-ups may decrease. Moreover, as the number of wake-ups decreases, it can be assumed that the amount of power consumed also decreases. Thus, for example, if a mobile terminal uses approximately 10 mW whenever it wakes up, 10 W could be saved in half an hour using the example described above and in reference to FIG. 5.

As indicated above, in some example embodiments, the apparatus 30 may further include a clustering agent 54. The clustering agent 54 may be configured to cluster mobile terminals together on the basis of their corresponding dynamic paging periods. In this regard, the clustering agent 54 may be configured to put mobile terminals that have the same (or similar within a predefined threshold) dynamic paging periods together into a group. Management of processes with regard to the terminals within the group may therefore be consolidated in order to reduce resource consumption further. As an example, if four mobile terminals are registered with the MSC 16 and the first has a dynamic paging period of 0.6 seconds, the second has a dynamic paging period of 0.7 seconds, the third has a dynamic paging period of 1.8 seconds and the fourth has a dynamic paging period of 1.9 seconds, the clustering agent 54 may be configured to cluster the first and second terminals together and cluster the third and fourth terminals together. In some examples, the clustering agent 54 may be further configured to compute an average of the paging periods for the terminals in each respective cluster and assign the average paging period to each terminal in the respective clusters. Thus, for the example above, the cluster including the first and second terminals may be assigned a paging period of 0.65 seconds. By assigning an average paging period to terminals in a cluster, the number of control channels broadcasting at the BS may be reduced while optimizing the effects of paging period management.

Although the example described above assumes that all the elements of FIG. 2 are embodied at the MSC 16, it is possible that some components may be embodied remotely from the MSC 16. For example, in some cases, the clustering agent 54 may be embodied at the BS 14. However, in other instances, clustering decisions may be performed at the MSC 16 and the clustering decisions may be communicated to the BS 14 for implementation at the BS 14. In other words, for example, the MSC 16 may make clustering decisions and inform the BS 14 so that the BS 14 may organize the clusters and communicate with the terminals in the clusters.

In another exemplary embodiment, the terminal movement monitor 52 may be embodied remotely at the mobile terminal 10 and movement information may be communicated back to the MSC 16, where the dynamic paging period determiner 50 may make dynamic paging period determinations that may be communicated to the BSs associated with the MSC 16 and/or to the mobile terminals themselves. In any event, embodiments of the present invention may provide for savings in power for individual mobile terminals that may, in the aggregate, account for vast power savings throughout an entire network.

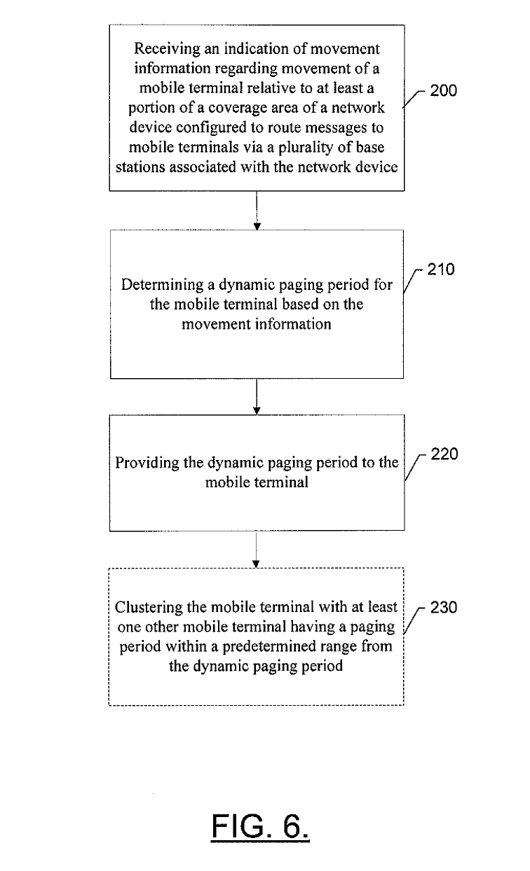

FIG. 6 is a flowchart of a system, method and program product according to exemplary embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of the mobile terminal or network device and executed by a processor in the mobile terminal or network device. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s) or step(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing dynamic paging period determination, as shown in FIG. 6, includes receiving an indication of movement information regarding movement of a mobile terminal relative to at least a portion of a coverage area of a network device configured to route messages to mobile terminals via a plurality of base stations associated with the network device at operation 200. The method may further include determining a dynamic paging period for the mobile terminal based on the movement information at operation 210 and providing the dynamic paging period to the mobile terminal at operation 220.

In some embodiments, certain ones of the operations above may be modified or further amplified as described below. It should be appreciated that each of the modifications or amplifications herein may be included with the operations and modifications above either alone or in combination with any others among the features described herein. In this regard, for example, receiving the indication of the movement information may include receiving an indication of residence timing information for the mobile terminal within a cell associated with one of the base stations or within the coverage area of the network device. Alternatively, receiving the indication of the movement information may include receiving an indication, for the mobile terminal, of registered cell identifications of cells within the coverage area of the network device. In some cases, determining the dynamic paging period may include defining a paging period that increases in proportion to an increase in a probability of the mobile terminal staying in the coverage area.

In some cases, further optional operations may be included in the method, an example of which is shown in dashed lines in FIG. 6. In this regard, for example, the method may further include clustering the mobile terminal with at least one other mobile terminal having a paging period within a predetermined range from the dynamic paging period at operation 230. In such an embodiment, the method may include defining a composite (e.g., average) paging period for the mobile terminal and the at least one other mobile terminal based on the paging period and the dynamic paging period.

In an exemplary embodiment, an apparatus for performing the method of FIG. 6 above may comprise a processor (e.g., the processor 40) configured to perform some or each of the operations (200-230) described above. The processor may, for example, be configured to perform the operations (200-230) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-230 may comprise, for example, the processor 40, the dynamic paging period determiner 50, respective ones of the terminal movement monitor 52 and the clustering agent 54, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-20. (canceled)

21. An apparatus comprising at least one processor and at least one memory including computer program code, the at least one memory and computer program code configured to, with the at least one processor, cause the apparatus to at least:
receive an indication of movement information regarding movement of a mobile terminal relative to at least a portion of a coverage area of a network device configured to route messages to mobile terminals via a plurality of base stations associated with the network device;
determine a dynamic paging period for the mobile terminal based on the movement information; and
provide the dynamic paging period to the mobile terminal.

22. The apparatus of claim 21, wherein the computer program code for causing the apparatus to receive the indication of the movement information includes instructions for causing the apparatus to receive an indication of residence timing information for the mobile terminal within a cell associated with one of the base stations.

23. The apparatus of claim 21, wherein the computer program code for causing the apparatus to receive the indication of the movement information includes instructions for causing the apparatus to receive an indication of residence timing information for the mobile terminal within the coverage area of the network device.

24. The apparatus of claim 21, wherein the computer program code for causing the apparatus to receive the indication of the movement information includes instructions for causing the apparatus to receive an indication, for the mobile terminal, of registered cell identifications of cells within the coverage area of the network device.

25. The apparatus of claim 21, wherein computer program code for causing the apparatus to determine the dynamic paging period includes instructions for causing the apparatus to define a paging period that increases in proportion to an increase in a probability of the mobile terminal staying in the coverage area.

26. The apparatus of claim 21, wherein the apparatus is further caused to cluster the mobile terminal with at least one other mobile terminal having a paging period within a predetermined range from the dynamic paging period.

27. The apparatus of claim 26, wherein clustering the mobile terminal with at least one other mobile terminal having a paging period within a predetermined range from the dynamic paging period includes defining a composite paging period for the mobile terminal and the at least one other mobile terminal based on the paging period and the dynamic paging period.

28. A method comprising:
receiving an indication of movement information regarding movement of a mobile terminal relative to at least a portion of a coverage area of a network device configured to route messages to mobile terminals via a plurality of base stations associated with the network device;
determining a dynamic paging period for the mobile terminal based on the movement information; and
providing the dynamic paging period to the mobile terminal.

29. The method of claim 28, wherein receiving the indication of the movement information includes receiving an indication of residence timing information for the mobile terminal within a cell associated with one of the base stations.

30. The method of claim 28, wherein receiving the indication of the movement information includes receiving an indication of residence timing information for the mobile terminal within the coverage area of the network device.

31. The method of claim 28, wherein receiving the indication of the movement information includes receiving an indication, for the mobile terminal, of registered cell identifications of cells within the coverage area of the network device.

32. The method of claim 28, wherein determining the dynamic paging period includes defining a paging period that increases in proportion to an increase in a probability of the mobile terminal staying in the coverage area.

33. The method of claim 28, further comprising clustering the mobile terminal with at least one other mobile terminal having a paging period within a predetermined range from the dynamic paging period.

34. A computer program product comprising a computer-readable medium bearing computer program code embodied therein for use with a computer, the computer program code comprising:
code for receiving an indication of movement information regarding movement of a mobile terminal relative to at least a portion of a coverage area of a network device configured to route messages to mobile terminals via a plurality of base stations associated with the network device;
code for determining a dynamic paging period for the mobile terminal based on the movement information; and
code for providing the dynamic paging period to the mobile terminal.

35. The computer program product of claim 34, wherein the code for receiving the indication of the movement information include code for receiving an indication of residence timing information for the mobile terminal within a cell associated with one of the base stations.

36. The computer program product of claim 34, wherein the code for receiving the indication of the movement information include code for receiving an indication of residence timing information for the mobile terminal within the coverage area of the network device.

37. The computer program product of claim 34, wherein the code for receiving the indication of the movement information include code for receiving an indication, for the mobile terminal, of registered cell identifications of cells within the coverage area of the network device.

38. The computer program product of claim 34, wherein the code for determining the dynamic paging period include instructions for defining a paging period that increases in proportion to an increase in a probability of the mobile terminal staying in the coverage area.

39. The computer program product of claim 34, further comprising code for clustering the mobile terminal with at least one other mobile terminal having a paging period within a predetermined range from the dynamic paging period.

40. The computer program product of claim 39, wherein the code for clustering the mobile terminal with the at least one other mobile terminal include code for defining a composite paging period for the mobile terminal and the at least one other mobile terminal based on the paging period and the dynamic paging period.
